(19) United States
(12) Patent Application Publication
(10) Pub. No.: US 2015/0284290 A1
(43) Pub. Date: Oct. 8, 2015

(54) METHOD FOR PRODUCING POROUS TITANIUM OXIDE LAMINATE

(71) Applicant: SEKISUI CHEMICAL CO., LTD., Osaka (JP)

(72) Inventors: Taku Sasaki, Osaka (JP); Mayumi Horiki, Osaka (JP)

(21) Appl. No.: 14/443,422

(22) PCT Filed: Jul. 12, 2013
(86) PCT No.: PCT/JP2013/069158

§ 371 Date: May 18, 2015

(30) Foreign Application Priority Data
Nov. 27, 2012 (JP) 2012-258997
Mar. 26, 2013 (JP) 2013-064759

(51) Int. Cl. C03C 25/62; C03C 25/00; C03C 17/25; H01G 9/20; H01G 9/00

(52) U.S. Cl. CPC C03C 25/6226; H01G 9/2031; H01G 9/0029; C03C 17/256; C03C 25/002; C03C 2217/212; C03C 2217/94; C03C 2217/425

(57) ABSTRACT

The present invention aims to provide a method for producing a porous titanium oxide laminate which enables production of a porous titanium oxide layer having a high porosity and containing fewer impurities even through low-temperature firing, and a dye-sensitized solar cell including the porous titanium oxide laminate. The present invention relates to a method for producing a porous titanium oxide laminate including the steps of: printing a titanium oxide paste containing titanium oxide fine particles, a (meth)acrylic resin, and an organic solvent on a base material for forming a titanium oxide paste layer on the base material; firing the titanium oxide paste layer; and irradiating the fired titanium oxide paste layer with ultraviolet light, the titanium oxide fine particles having an average particle size of 5 to 50 nm, the ultraviolet light being radiated in a total amount of 100 J/cm² or more in the step of irradiating the fired titanium oxide paste layer with ultraviolet light.

### TECHNICAL FIELD

The present invention relates to a method for producing a porous titanium oxide laminate which enables production of a porous titanium oxide layer having a high porosity and containing fewer impurities even through low-temperature firing, and a dye-sensitized solar cell including the porous titanium oxide laminate.

### BACKGROUND ART

In the face of exhaustion of fossil fuels and global warming, solar cells are now drawing much attention as clean energy sources, and research and development thereof are actively advanced.

Conventional solar cells having been applied to practical use are silicon solar cells typified by monocrystalline Si solar cells, polycrystalline Si solar cells, amorphous Si solar cells, and the like. Now, next-generation solar cells are increasingly desired because the silicon solar cells are expensive and a problem of a shortage of Si as a raw material is surfacing.

Organic solar cells are now receiving attention as solar cells overcoming above problems. In particular, a dye-sensitized solar cell is receiving a lot of attention. A dye-sensitized solar cell is comparatively easily produced from inexpensive raw materials and has high photoelectric conversion efficiency, and therefore is considered to be a probable next-generation solar cell. In a dye-sensitized solar cell, titanium oxide formed into a layer is conventionally used as an electrode material. The titanium oxide layer has functions of 1) adsorbing sensitizing dyes, 2) accepting electron injection from the excited sensitizing dyes, 3) transferring the electrons to a conductive layer, 4) providing a reaction field for electron transfer from iodide ions to the dyes (reduction), and 5) performing light scattering and light confinement, and is one of the most important factors that determines the performance of a solar cell.

In the function of 1) adsorbing sensitizing dyes, for the purpose of improving the photoelectric conversion efficiency, a larger amount of sensitizing dyes are required to be adsorbed. Accordingly, the titanium oxide layer is required to be porous, thereby increasing the surface area. Moreover, the amount of impurities in the titanium oxide layer is required to be minimized. A commonly employed method for forming a porous titanium oxide layer includes printing a paste containing titanium oxide particles and an organic binder on a base material, volatilizing a solvent, and scavenging the organic binder by high-temperature firing. This method enables production of a porous film in which titanium oxide particles are sintered and a large number of fine voids are present.

An organic binder commonly used in such a paste containing titanium oxide particles is ethyl cellulose from the standpoint of dispersion retainability of the titanium oxide particles and printing properties such as viscosity of the paste. For complete scavenging of ethyl cellulose, however, high-temperature firing at a temperature exceeding 500° C. is needed. In this case, a resin base material that is enjoying a growing need for further cost reduction is problematically not usable. In a case where low-temperature firing is performed, residues of the organic binder may remain on the titanium oxide particle surface, so that the sensitizing dyes are not adsorbed. As a result, the photoelectric conversion efficiency is significantly lowered.

To solve the problem, Patent Literature 1 discloses firing at low temperatures using a paste having a lower organic binder content. The paste disclosed in Patent Literature 1 however has a low viscosity so as to be difficult to retain its shape upon printing, which causes problems such as non-uniform thickness of the film, collapse of end portions, and aggregation of wirings in a case where the paste is printed in the form of fine wirings.

Moreover, in the case of using ethyl cellulose as an organic binder, a lower alcohol, a mixed solvent containing a lower alcohol and a high-viscosity solvent such as terpineol or the like is used as a solvent. Since the paste, upon printing, is exposed to the outside air for a long time and subjected to an external force such as a strong shearing force from devices (e.g., a printing plate, a squeegee), volatilization of a dispersing medium before printing increases the viscosity of the paste to possibly change the printability. This phenomenon causes another problem that stable production is difficult.

In contrast, in a dye-sensitized solar cell, a maximum possible amount of sensitizing dyes is preferably supported for the purpose of improving the photoelectric conversion efficiency. In the case of using a paste containing a conventional organic binder, however, a sufficient amount of the sensitizing dyes may not be supported, or supporting of the sensitizing dyes may require a long time.

### CITATION LIST

### Patent Literature

Patent Literature 1: Japanese Patent No. 4801899

### SUMMARY OF INVENTION

### Technical Problem

The present invention aims to provide a method for producing a porous titanium oxide laminate which enables production of a porous titanium oxide layer having a high porosity and containing fewer impurities even through low-temperature firing, and a dye-sensitized solar cell including the porous titanium oxide laminate.

### Solution to problem

The present invention provides a method for producing a porous titanium oxide laminate including the steps of: printing a titanium oxide paste containing titanium oxide fine particles, a (meth)acrylic resin, and an organic solvent on a base material for forming a titanium oxide paste layer on the base material; firing the titanium oxide paste layer; and irradiating the fired titanium oxide paste layer with ultraviolet light, the titanium oxide fine particles having an average particle size of 5 to 50 nm, the ultraviolet light being radiated in a total amount of 100 J/cm² or more in the step of irradiating the fired titanium oxide paste layer with ultraviolet light.

The present invention is specifically described in the following.

As a result of the intensive studies, the present inventors have found out the following. Specifically, in a method for producing a porous titanium oxide laminate using a titanium oxide paste containing titanium oxide fine particles, a (meth)acrylic resin, and an organic solvent, a step of irradiating a titanium oxide paste layer with ultraviolet light after firing enables production of a porous titanium oxide layer having a high porosity and containing fewer impurities even through low-temperature firing. Accordingly, in a case where the porous titanium oxide layer is used as a material of a dye-sensitized solar cell, high photoelectric conversion efficiency can be achieved.

The present inventors have also found out that a dye-sensitized solar cell produced using such a porous titanium oxide laminate can adsorb sensitizing dyes sufficiently in a short time, thereby completing the present invention.

The method for producing a porous titanium oxide laminate of the present invention includes a step of printing a titanium oxide paste on a base material to form a titanium oxide paste layer on the base material.

The titanium oxide paste may be printed on a base material by any method, and screen printing is preferably employed.

In a case where the base material has flexibility, continuous printing by the roll-to-roll method is greatly advantageous in terms of mass productivity and production cost.

The aperture size of a screen plate, an attack angle, a moving speed, and a pressure force of a squeegee, and the like in a process by the screen printing method are preferably appropriately determined.

In the step of printing a titanium oxide paste on a base material, the base material may be a transparent substrate having a transparent conductive layer formed thereon, for example, in a case where the resulting porous titanium oxide laminate is used for production of a dye-sensitized solar cell.

The transparent substrate is not particularly limited as long as it is transparent, and examples thereof include a glass substrate such as silicate glass. The glass substrate may be chemically or thermally reinforced. Various plastic substrates are also usable as long as light transmission is ensured.

The transparent substrate has a thickness of preferably 0.1 to 10 mm and more preferably 0.3 to 5 mm.

Examples of the transparent conductive layer include layers of conductive metal oxides such as In₂O₃ and SnO₂ and layers of conductive materials such as metals. Examples of the conductive metal oxides include In₂O₃:Sn (ITO), SnO₂:Sb, SnO₂:F, ZnO:Al, ZnO:F, and CdSnO₄.

The titanium oxide paste contains titanium oxide fine particles. Titanium oxide is suitably used as it has a wide band gap and resources thereof are comparatively plenty.

Common examples of the titanium oxide fine particles include rutile titanium oxide fine particles, anatase titanium oxide fine particles, brookite titanium oxide fine particles, and titanium oxide fine particles obtainable by modifying these crystallizable titanium oxides.

The lower limit of the average particle size of the titanium oxide fine particles is 5 nm and the upper limit thereof is 50 nm. The lower limit is preferably 10 nm and the upper limit is preferably 25 nm. When the average particle size is within the above range, a resulting porous titanium oxide layer has a sufficient specific surface area. Moreover, recombination of electrons with electron holes is also avoided. Alternatively, two or more kinds of fine particles different in the particle size distribution may be mixed together.

The lower limit of the amount of the titanium oxide fine particles is preferably 5% by weight and the upper limit thereof is preferably 75% by weight relative to the amount of the titanium oxide paste. If the amount is less than 5% by weight, a resulting porous titanium oxide layer may not have a sufficient thickness. If the amount is more than 75% by weight, the paste may have an increased viscosity so as not to be smoothly printed. The lower limit is more preferably 10% by weight and the upper limit is more preferably 50% by weight. The lower limit is still more preferably 20% by weight and the upper limit is still more preferably 35% by weight.

The titanium oxide paste contains a (meth)acrylic resin. Since the (meth)acrylic resin is excellent in decomposition at low temperatures, the resulting titanium oxide paste leaves fewer organic residues even in the case of being subjected to low-temperature firing. Moreover, since the (meth)acrylic resin has low viscosity characteristics, a change in the viscosity characteristics is remarkably suppressed even in a case where a solvent is volatilized in a working environment, leading to stable printing.

Any (meth)acrylic resin may be used as long as it is decomposed at low temperatures (at around 300° C.). Examples thereof include polymers polymerized at least one kind of monomer selected from the group consisting of methyl (meth)acrylate, ethyl (meth)acrylate, propyl (meth)acrylate, n-butyl (meth)acrylate, tert-butyl (meth)acrylate, isobutyl (meth)acrylate, cyclohexyl (meth)acrylate, 2-ethyl hexyl (meth) acrylate, isobornyl (meth) acrylate, n-stearyl (meth)acrylate, benzyl (meth)acrylate, and (meth)acrylic monomers having a polyoxyalkylene structure. The term “(meth)acrylate” herein refers to “acrylate” and/or “methacrylate”. In particular, since a high viscosity is achieved with a small amount of resin, preferred is polyisobutyl methacrylate (isobutyl methacrylate polymer) that is a polymer of methyl methacrylate having a high glass transition temperature (Tg) and an excellent degreasing power at low temperatures.

The lower limit of the polystyrene-equivalent weight average molecular weight of the (meth)acrylic resin is preferably 5000 and the upper limit thereof is preferably 500000. If the weight average molecular weight is less than 5000, the resin may fail to give sufficient viscosity to the resulting paste, so that the paste is not appropriate for printing. In contrast, if the weight average molecular weight is more than 500000, the resulting titanium oxide paste may have a high adhesive force and may be stringy, resulting in lowered printability. The upper limit of the weight average molecular weight is more preferably 100000 and still more preferably 50000. The polystyrene-equivalent weight average molecular weight is determined by GPC measurement using a Column LF-804 (available from SHOKO) as a column.

The (meth)acrylic resin content of the titanium oxide paste is not particularly limited, and the lower limit thereof is preferably 10% by weight and the upper limit thereof is preferably 50% by weight. If the (meth)acrylic resin content is less than 10% by weight, the resulting titanium oxide paste may not have a sufficient viscosity, resulting in lowered printability. In contrast, if the (meth)acrylic resin content is more than 50% by weight, the resulting titanium oxide paste may have too high a viscosity and too high an adhesive force, resulting in poor printability.

The (meth)acrylic resin content is preferably smaller than the titanium oxide fine particle content. If the (meth)acrylic resin content is larger than the titanium oxide fine particle content, the amount of a residual (meth)acrylic resin after heating may increase.

The titanium oxide paste may contain, in addition to the (meth)acrylic resin, a small amount of another binder resin to the extent that will not leave impurities even after firing at low temperatures. Examples of the binder resin include polyvinyl alcohol (PVA), polyvinyl butyral (PVB), polyethylene glycol, polystyrene, and polylactic acid.

The titanium oxide paste contains an organic solvent. Preferably, the organic solvent dissolves a (meth)acrylic resin well and has a high polarity. Examples thereof include terpene solvents (e.g., α-terpineol, γ-terpineol) alcohol solvents (e.g., ethanol, isopropyl alcohol), polyvalent alcohol solvents (e.g., diol, triol), mixed solvents of the alcohol solvent/hydrocarbon and the like, and hetero compounds (e.g., dimethyl formamide, dimethyl sulfoxide, tetrahydrofuran). Among these, preferred are terpene solvents.

The organic solvent preferably has a boiling point of 100 to 300° C. If the boiling point of the organic solvent is lower than 100° C., the resulting titanium oxide paste tends to be dried during printing and may be disadvantageous when used in continuous printing for a long time. If the boiling point is higher than 300° C., the resulting titanium oxide paste has poor drying characteristics in the drying step after printing. The boiling point refers to a boiling point at normal pressure.

The lower limit of the organic solvent content is preferably 55% by weight and the upper limit thereof is preferably 74% by weight. If the organic solvent content is less than 55% by weight, the resulting titanium oxide paste may have a high viscosity, possibly leading to poor printability. If the organic solvent content is more than 74% by weight, the resulting titanium oxide paste has too low a viscosity, possibly leading to poor printability. The lower limit is more preferably 60% by weight and the upper limit is more preferably 70% by weight.

The titanium oxide paste preferably contains a photoacid generator. In a case where the titanium oxide paste contains the photoacid generator, two reactions occur, including oxidative decomposition by ultraviolet light described later and organic matter decomposition by an acid derived from the photoacid generator. In this case, residue decomposition is more effectively performed.

The photoacid generator is not particularly limited as long as it generates an acid under irradiation with light. Examples of the photoacid generator include compounds obtainable by ester-bonding of acid compounds and light-absorbing compounds. Specific examples of the photoacid generator include: sulfonium salt compounds such as “TPS-105” (CAS No. 66003-78-9), “TPS-109” (CAS No. 144317-44-2), “MDS-105” (CAS No. 116808-67-4), “MDS-205” (CAS No. 81416-37-7), “DTS-105” (CAS No. 111281-12-0), “NDS-105” (CAS No. 195057-83-1), and “NDS-165” (CAS No. 316821-98-4) (product names, all available from Midori Kagaku Co., Ltd.,); iodonium salt compounds such as “DPI-105” (CAS No. 66003-76-7), “DPI-106” (CAS No. 214534-44-8), “DPI-109” (CAS No. 194999-82-1), “DPI-201” (CAS No. 6293-66-9), “BI-105” (CAS No. 154557-16-1), “MPI-105” (CAS No. 115298-63-0), “MPI-106” (CAS No. 260061-46-9), “MPI-109” (CAS No. 260061-47-0), “BBI-105” (CAS No. 84563-54-2), “BBI-106” (CAS No. 185195-30-6), “BBI-109” (CAS No. 194999-85-4), “BBI-110” (CAS No. 213740-80-8), and “BBI-201” (CAS No. 142342-33-4); sulfonic acid ester compounds such as “NAI-106” (naphthalimide camphor sulfonic acid salt, CAS No. 83697-56-7), “NAI-100” (CAS No. 83697-53-4), “NAI-1002” (CAS No. 76656-48-9), “NAI-1004” (CAS No. 83697-60-3), “NAI-101” (CAS No. 5551-72-4), “NAI-105” (CAS No. 85342-62-7), “NAI-109” (CAS No. 171417-91-7), “NI-101” (CAS No. 131526-99-3), “NI-105” (CAS No. 85342-63-8), “NDI-101” (CAS No. 141714-82-1), “NDI-105” (CAS No. 133710-62-0), “NDI-106” (CAS No. 210218-57-8), “NDI-109” (CAS No. 307531-76-6), “PAI-01” (CAS No. 17512-88-8), “PAI-101” (CAS No. 82424-53-1), “PAI-106” (CAS No. 202419-88-3), “PAI-1001” (CAS No. 193222-02-5), “SI-101” (CAS No. 55048-39-0), “SI-105” (CAS No. 34684-40-7), “SI-106” (CAS No. 179419-32-0), “SI-109” (CAS No. 252937-66-9), “PI-105” (CAS No. 41580-58-9), “PI-106” (CAS No. 83697-51-2) (product names, all available from Midori Kagaku Co., Ltd.), “PAG-121”, “CGI1397”, “CGI1325”, “CGI1380”, “CGI1311”, “CGI263”, and “CGI268” (product names, all available from Ciba Specialty Chemicals Inc.); and compounds containing BF₄⁻ as a counter ion such as “DTS200” (CAS No. 203573-06-2) (product name, available from Midori Kagaku Co., Ltd.) and “RHODORSIL PHOTOINITIATOR-2074” (CAS No. 178233-72-2) (product name, available from Rhodia Japan). Each of these photoacid generators may be used alone, or two or more of these may be used in combination.

In particular, preferred is a photoacid generator having a structure represented by Formula (1).

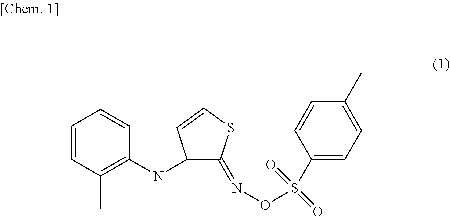 [SMILES: Cc1ccc(S(=O)(=O)O/N=C2\SC=CC2Nc2ccccc2C)cc1]

The photoacid generator content is not particularly limited, and the lower limit thereof is preferably 0.0025% by weight and the upper limit thereof is preferably 2.5% by weight. If the photoacid generator content is less than 0.0025% by weight, addition of a photoacid generator may fail to give a sufficient effect of organic matter decomposition. In contrast, if the photoacid generator content is more than 2.5% by weight, the proportion of the light-absorbing compound to the paste increases to possibly give an adverse influence, for example. The lower limit is more preferably 0.025% by weight and the upper limit is more preferably 1.25% by weight.

The lower limit of the viscosity of the titanium oxide paste is preferably 15 Pa·s and the upper limit thereof is preferably 50 Pa·s. If the viscosity is lower than 15 Pa·s, shape retention upon printing may be difficult. If the viscosity is higher than 50 Pa·s, the resulting titanium oxide paste may have poor coatability. The lower limit of the viscosity is more preferably 17.5 Pa·s and the upper limit thereof is more preferably 45 Pa·s.

The viscosity is determined by measuring a dynamic viscosity upon shearing at 25° C. at 10 rpm using an E-type viscometer.

The lower limit of the thixotropic ratio of the titanium oxide paste is preferably 2. If the thixotropic ratio is less than 2, shape retention after printing is difficult, possibly causing problems of non-uniform thickness of the film, collapse of end portions, and aggregation of wirings in a case where the paste is printed in the form of fine wirings. The lower limit of the thixotropic ratio is more preferably 2.25 and the upper limit thereof is preferably 5. The thixotropic ratio is determined by dividing the dynamic viscosity upon shearing at 0.5 rpm by the dynamic viscosity upon shearing at 5 rpm measured at 25° C. using an E-type viscometer.

The titanium oxide paste has a rate of change in viscosity of preferably 105% or less in a case where a squeegee operation is repeated 25 times at ambient temperature in air atmosphere. If the rate of change in viscosity is more than 105%, printability may vary. In such a case, stable production is difficult.

The rate of change in viscosity is determined as follows. A titanium oxide paste is put on a glass plate, thinly stretched with a rubber squeegee on the glass surface, and scraped off. This operation is repeated 25 times, and the ratio of the viscosity before and after the operations is calculated. Here, the viscosity is determined by measuring a dynamic viscosity upon shearing at 25° C. at 10 rpm using an E-type viscometer.

The titanium oxide paste preferably contains a (meth)acrylic resin and an organic solvent in an amount of 1% by weight or less after being heated from 25° C. to 300° C. in air atmosphere at a rate of temperature rise of 10° C./min.

Having less surface impurities after heating, the titanium oxide paste tends to have coupling (necking) of fine particles. As a result, inter-particle resistance can be reduced. In a case where such paste is used as a material of a dye-sensitized solar cell, high photoelectric conversion efficiency can be realized.

If the amount is more than 1% by weight, impurities are left on the titanium oxide fine particle surface, so that sensitizing dyes cannot be adsorbed. The amount is an amount relative to the amount of the titanium oxide fine particles.

The titanium oxide paste is excellent in printability, and also is capable of producing a porous titanium oxide layer having a high porosity and containing fewer impurities even through low-temperature firing.

In addition, the titanium oxide paste is excellent in compatibility with an organic solvent commonly used for washing of a screen plate and can be sufficiently removed by washing after use thereof. Accordingly, the screen plate is less likely to be clogged, so that screen printing can be performed stably for a long time.

Moreover, the titanium oxide paste, when used as a material for a dye-sensitized solar cell, can sufficiently adsorb sensitizing dyes in a short time, so that the resulting dye-sensitized solar cell has high photoelectric conversion efficiency.

As a method of producing the titanium oxide paste, a method including a step of mixing titanium oxide fine particles, a (meth)acrylic resin, and an organic solvent may be employed. Exemplary means for the mixing include a two-roll mill, a three-roll mill, a bead mill, a ball mill, a disperser, a planetary mixer, a rotation and revolution type mixer, a kneader, an extruder, a mix rotor, and a stirrer.

The method for producing a porous titanium oxide laminate of the present invention includes a step of firing the titanium oxide paste layer.

The temperature, time, atmosphere and the like for the firing of the titanium oxide paste layer may be appropriately adjusted in accordance with the kind or the like of the substrate to which the paste is applied.

For example, the firing is performed in the air or inert gas atmosphere at a temperature in a range from about 50° C. to about 800° C. for 10 seconds to 12 hours.

The drying and firing may be performed once at a single temperature or performed more than once at different temperatures.

The method for producing a porous titanium oxide laminate of the present invention includes a step of irradiating the fired titanium oxide paste layer with ultraviolet light. Through this step, a catalyst activation effect by the titanium oxide enables oxidative decomposition of a slight amount of organic residues present in the titanium oxide paste layer. Accordingly, in a case where the titanium oxide paste layer is used as a material of a dye-sensitized solar cell, for example, the performance can be further improved. Such an effect given by irradiation with ultraviolet light is especially remarkably exerted in a case where a (meth)acrylic resin is used as an organic binder. Moreover, in the present invention, the use of titanium oxide particles having a small average particle size can increase the contact area with the organic binder. Consequently, the catalyst activation effect by the titanium oxide is further enhanced.

In the step of irradiation with ultraviolet light, the total amount of radiated ultraviolet light is 100 J/cm² or more. If the total amount of radiated ultraviolet light is less than 100 J/cm², organic residues cannot be sufficiently removed. The lower limit of the amount is preferably 150 J/cm² and the upper limit thereof is preferably 10000 J/cm².

The total amount of radiated ultraviolet light is simply calculated by the formula: (irradiation intensity (mW/cm²))×(irradiation time (seconds)).

In the step of irradiation with ultraviolet light, the irradiation intensity of ultraviolet light is preferably from 0.5 to 1000 mW/cm².

The irradiation time with ultraviolet light is preferably from 1 second to 300 minutes and more preferably from 1 second to 60 minutes. If the irradiation intensity is too low or the irradiation time is too short, removal of organic residues proceeds only partly, failing to achieve a sufficient effect. If the irradiation intensity is too high or the irradiation time is too long, the transparent substrate may suffer from ultraviolet degradation or thermal degradation.

Irradiation with ultraviolet light may be performed by any method, for example, by a method using a low pressure mercury lamp, a high pressure mercury lamp, a mercury-xenon lamp or the like.

In the step of irradiation with ultraviolet light, both faces of the fired titanium oxide paste layer, namely a front face (opposite side of the substrate) and a rear face (substrate side) are preferably irradiated with ultraviolet light. In such a case, the titanium oxide paste layer is sufficiently irradiated to the inside with ultraviolet light. As a result, even if the total amount of radiated ultraviolet light is small, the effect of ultraviolet light irradiation can be sufficiently achieved, leading to shortening of the time required for the production process. Irradiation of the front face and irradiation of the rear face may be concurrently performed or performed in succession in plural times.

In the present invention, after the step of irradiation with ultraviolet light, a step of irradiation with pulsed white light having a narrow pulse width is preferably performed. Irradiation with the pulsed white light causes densification of titanium oxide particles by melting of surfaces thereof in the titanium oxide paste layer, enabling lowering of the surface resistance.

The pulsed light preferably has a pulse width of 0.1 to 10 ms. This allows irradiation with strong light energy in a moment.

The total amount of radiated pulsed light is not particularly limited, and is preferably 4 J/cm² or more. In such a case, applied energy is enough for fusion of particles. The total amount of radiated pulsed light is more preferably from 15 to 40 J/cm². In addition, the number of irradiation times is preferably 1 to 5 times.

Examples of means for irradiation with the pulsed light include a halogen flash lamp, a xenon flash lamp, and an LED flash lamp. Particularly preferred is a xenon flash lamp.

In the method for producing a porous titanium oxide laminate of the present invention, a porous titanium oxide laminate including a porous titanium oxide layer formed on the substrate is produced through the above steps.

Thus obtained porous titanium oxide laminate is subjected to a step of adsorbing sensitizing dyes, and set to face a counter electrode. Then, an electrolyte layer is formed between these electrodes, thereby completing production of a dye-sensitized solar cell. Thus obtained dye-sensitized solar cell can achieve high photoelectric conversion efficiency. An exemplary method for the step of adsorbing sensitizing dyes include immersing the porous titanium oxide laminate in an alcohol solution of sensitizing dyes and then removing the alcohol by drying.

Examples of the sensitizing dye include ruthenium dyes such as ruthenium-tris type dyes and ruthenium-bis type dyes; and organic dyes such as phthalocyanine, porphyrin, cyanidin dyes, merocyanine dyes, rhodamine dyes, xanthene dyes, and triphenyl methane dyes.

### Advantageous Effects of Invention

The present invention can provide a method for producing a porous titanium oxide laminate which can produce a porous titanium oxide layer having a high porosity and containing fewer impurities even through low-temperature firing, and a dye-sensitized solar cell including the porous titanium oxide laminate.

### DESCRIPTION OF EMBODIMENTS

The present invention is more specifically described with reference to examples. It is to be noted that the present invention is not limited only to these examples.

### Example 1

### Preparation of Titanium Oxide Paste

A titanium oxide paste was prepared by uniformly mixing titanium oxide fine particles having an average particle size of 20 nm, isobutyl methacrylate polymers (weight average molecular weight of 50000) as an organic binder, and α-terpineol (boiling point of 219° C.) as an organic solvent in accordance with the formulation shown in Table 1 using a bead mill.

### (Formation of Porous Titanium Oxide Layer)

The prepared titanium oxide paste was printed in the shape of a 5-mm square on a glass substrate having a FTO transparent electrode in a 25-mm square shape formed thereon, and then fired at 300° C. for one hour.

The fired layer is irradiated with ultraviolet light from the side (front side) opposite to the glass substrate side at an irradiation intensity of 100 mW/cm² for 30 minutes using a high pressure mercury lamp (product of SEN LIGHTS Co., Ltd., HLR100T-2), thereby providing a porous titanium oxide layer. Print conditions were adjusted in such a manner that the resulting porous titanium oxide layer had a thickness of 10 μm.

### (Production of Dye-Sensitized Solar Cell)

The resulting substrate with a porous titanium oxide layer was immersed for one day in a solution (concentration of 0.3 mM) of a Ru complex dye (N719) in acetonitrile and t-butanol (ratio at 1:1), thereby adsorbing sensitizing dyes on the surface of the porous titanium oxide layer.

Next, on the substrate, a film having a thickness of 30 μm available from Himilan was placed so as to surround the porous titanium oxide layer except for one side of the layer. On that film, a glass substrate with a platinum electrode deposited thereon was further placed. A space between the substrates was filled with a solution of lithium iodide and iodine in acetonitrile and then sealed. In this manner, a dye-sensitized solar cell was produced.

### Examples 2 to 8

Porous titanium oxide layers and dye-sensitized solar cells were produced in the same manner as in Example 1, except that the amounts of the organic binder and the organic solvent, the firing temperature, the irradiation time with ultraviolet light, and the total amount of radiated ultraviolet light were changed as shown in Table 1.

Besides the α-terpineol (boiling point of 219° C.), 2,4-diethyl-1,5-pentanediol (PD-9, boiling point of 264° C.) was also used as the organic solvent.

### Example 9

A porous titanium oxide layer and a dye-sensitized solar cell were produced in the same manner as in Example 7, except that, in the (Formation of porous titanium oxide layer), irradiation with ultraviolet light was performed from the side (front side) opposite to the glass substrate side at an irradiation intensity of 100 mW/cm² for 15 minutes using a high pressure mercury lamp (product of SEN LIGHTS Co., Ltd., HLR100T-2) and then further performed from the glass substrate side (rear side) at an irradiation intensity of 100 mW/cm² for 15 minutes.

### Example 10

A porous titanium oxide layer and a dye-sensitized solar cell were produced in the same manner as in Example 7, except that, in the (Formation of porous titanium oxide layer), irradiation with ultraviolet light was performed from the side (front side) opposite to the glass substrate side at an irradiation intensity of 100 mW/cm² for 30 minutes using a high pressure mercury lamp (product of SEN LIGHTS Co., Ltd., HLR100T-2) and then further performed from the glass substrate side (rear side) at an irradiation intensity of 100 mW/cm² for 30 minutes.

### Examples 11 and 12

Porous titanium oxide layers and dye-sensitized solar cells were produced in the same manner as in Example 7, except that, in the (Preparation of titanium oxide paste), titanium oxide fine particles used had an average particle size as shown in Table 1.

### Examples 13 and 14

Porous titanium oxide layers and dye-sensitized solar cells were produced in the same manner as in Example 8, except that, in the (Preparation of titanium oxide paste), titanium oxide fine particles used had an average particle size as shown in Table 1.

### Examples 15 to 20

Porous titanium oxide layers and dye-sensitized solar cells were produced in the same manner as in Example 7, except that the amounts of the organic binder and the organic solvent, the amount of the photoacid generator, the firing temperature, the irradiation time with ultraviolet light, and the total amount of radiated ultraviolet light were changed as shown in Table 1. The photoacid generator used had a structure represented by the above Formula (1).

### Examples 21 to 29

Porous titanium oxide layers and dye-sensitized solar cells were produced in the same manner as in Example 7, except that, in the (Formation of porous titanium oxide layer), irradiation with ultraviolet light was performed from the side (front side) opposite to the glass substrate side at an irradiation intensity of 100 mW/cm² for 30 minutes using a high pressure mercury lamp and then irradiation with pulsed light was performed under the conditions (amount of light, irradiation time, the number of irradiation times) as shown in Table 1 using a xenon flash lamp (product of ALTECH CO., LTD., Sinteron2000).

TABLE 1

| | | Formulation ratio of paste (% by weight) | | | | | | |
|---|---|---|---|---|---|---|---|---|
| | | | Average | | | | | |
| | | titanium | particle | | Organic | Organic | | Firing |
| | | oxide | size | Organic | solvent | solvent | Photoacid | temperature |
| | Organic binder | particles | (nm) | binder | α-terpineol | PD-9 | generator | (° C.) |
| Example 1 | Isobutyl | 25 | 20 | 10 | 65 | — | — | 300 |
| Example 2 | methacrylate | | | | | | | 300 |
| Example 3 | polymer | | | | | | | 150 |
| Example 4 | | | | | | | | 150 |
| Example 5 | | | | 2.5 | 5 | 67.5 | | 300 |
| Example 6 | | | | | | | | 300 |
| Example 7 | | | | | | | | 150 |
| Example 8 | | | | | | | | 150 |
| Example 9 | | | | | | | | 150 |
| Example 10 | | | | | | | | 150 |
| Example 11 | | | 6 | | | | | 150 |
| Example 12 | | | 45 | | | | | 150 |
| Example 13 | | | 6 | | | | | 150 |
| Example 14 | | | 45 | | | | | 150 |
| Example 15 | | | 20 | | | 67.25 | 0.25 | 150 |
| Example 16 | | | | | | 67.475 | 0.025 | 150 |
| Example 17 | | | | | | 66.5 | 1 | 150 |
| Example 18 | | | | | | 67.25 | 0.25 | 150 |
| Example 19 | | | | | | 67.475 | 0.025 | 150 |
| Example 20 | | | | | | 66.5 | 1 | 150 |
| Example 21 | | | | | | 67.5 | — | 150 |
| Example 22 | | | | | | | | 150 |
| Example 23 | | | | | | | | 150 |
| Example 24 | | | | | | | | 150 |
| Example 25 | | | | | | | | 150 |
| Example 26 | | | | | | | | 150 |
| Example 27 | | | | | | | | 150 |
| Example 28 | | | | | | | | 150 |
| Example 29 | | | | | | | | 150 |

| | | Irradiation | | | Irradiation with pulsed light | | |
|---|---|---|---|---|---|---|---|
| | | time with | | Total | Amount | | |
| | Irradiation | ultraviolet | | amount of | of | Irradiation | |
| | intensity | light | Ultraviolet light | light | light | time | Number |
| | (mW/cm²) | (min.) | irradiation method | (J/cm²) | (J/cm²) | (msec) | of times |
| Example 1 | 100 | 30 | From front side only | 180 | — | — | — |
| Example 2 | 100 | 60 | From front side only | 360 | — | — | — |
| Example 3 | 100 | 30 | From front side only | 180 | — | — | — |
| Example 4 | 100 | 60 | From front side only | 360 | — | — | — |
| Example 5 | 100 | 30 | From front side only | 180 | — | — | — |
| Example 6 | 100 | 60 | From front side only | 360 | — | — | — |
| Example 7 | 100 | 30 | From front side only | 180 | — | — | — |
| Example 8 | 100 | 60 | From front side only | 360 | — | — | — |
| Example 9 | 100 | 30 | From front side for | 180 | — | — | — |
| | | | 15 min. + from rear | | | | |
| | | | side for 15 min. | | | | |
| Example 10 | 100 | 60 | From front side for | 360 | — | — | — |
| | | | 30 min. + from rear | | | | |
| | | | side for 30 min. | | | | |
| Example 11 | 100 | 30 | From front side only | 180 | — | — | — |
| Example 12 | 100 | 30 | From front side only | 180 | — | — | — |
| Example 13 | 100 | 60 | From front side only | 360 | — | — | — |
| Example 14 | 100 | 60 | From front side only | 360 | — | — | — |
| Example 15 | 100 | 30 | From front side only | 180 | — | — | — |
| Example 16 | 100 | 30 | From front side only | 180 | — | — | — |
| Example 17 | 100 | 30 | From front side only | 180 | — | — | — |
| Example 18 | 100 | 60 | From front side only | 360 | — | — | — |
| Example 19 | 100 | 60 | From front side only | 360 | — | — | — |
| Example 20 | 100 | 60 | From front side only | 360 | — | — | — |
| Example 21 | 100 | 30 | From front side only | 180 | 20 | 2 | 1 |
| Example 22 | 100 | 30 | From front side only | 180 | 4 | 2 | 1 |
| Example 23 | 100 | 30 | From front side only | 180 | 40 | 2 | 1 |
| Example 24 | 100 | 30 | From front side only | 180 | 2 | 2 | 1 |
| Example 25 | 100 | 30 | From front side only | 180 | 50 | 2 | 1 |
| Example 26 | 100 | 30 | From front side only | 180 | 20 | 2 | 3 |
| Example 27 | 100 | 30 | From front side only | 180 | 20 | 2 | 5 |
| Example 28 | 100 | 30 | From front side only | 180 | 20 | 1 | 1 |
| Example 29 | 100 | 30 | From front side only | 180 | 20 | 10 | 1 |

### Comparative Examples 1 to 3

Porous titanium oxide layers and dye-sensitized solar cells were produced in the same manner as in Example 1, except that ethyl cellulose (product of Wako Pure Chemical Industries, Ltd, 45% ethoxy, 10 cP) was used as the organic binder, instead of the isobutyl methacrylate polymers, and the firing temperature, the irradiation time with ultraviolet light, and the total amount of radiated ultraviolet light were changed as shown in Table 2.

### Comparative Examples 4 to 12

Porous titanium oxide layers and dye-sensitized solar cells were produced in the same manner as in Example 1, except that the amounts of the organic binder and the organic solvent, the firing temperature, the irradiation time with ultraviolet light, and the total amount of radiated ultraviolet light were changed as shown in Table 2.

### Comparative Example 13

A porous titanium oxide layer and a dye-sensitized solar cell were produced in the same manner as in Example 1, except that, in the (Formation of porous titanium oxide layer), irradiation with ultraviolet light was performed from the side (front side) opposite to the glass substrate side at an irradiation intensity of 100 mW/cm² for 7.5 minutes using a high pressure mercury lamp (product of SEN LIGHTS Co., Ltd., HLR100T-2) and then further irradiated from the glass substrate side (rear side) at an irradiation intensity of 100 mW/cm² for 7.5 minutes.

### Comparative Examples 14 and 15

Porous titanium oxide layers and dye-sensitized solar cells were produced in the same manner as in Example 7, except that, in the (Preparation of titanium oxide paste), titanium oxide fine particles used had an average particle size as shown in Table 2.

### Comparative Examples 16 and 17

Porous titanium oxide layers and dye-sensitized solar cells were produced in the same manner as in Example 8, except that, in the (Preparation of titanium oxide paste), titanium oxide fine particles used had an average particle size shown in Table 2.

TABLE 2

Formulation ratio of paste (% by weight)

| | | Titanium | Average | | Organic | Organic | | Firing |
|---|---|---|---|---|---|---|---|---|
| | | oxide | particle | Organic | solvent | solvent | Photoacid | temperature |
| | Organic binder | particles | size (nm) | binder | α-terpineol | PD-9 | generator | (° C.) |
| Comparative | Ethyl cellulose | 25 | 20 | 10 | 65 | — | — | 300 |
| Example 1 | | | | | | | | |
| Comparative | | | | | | | | 300 |
| Example 2 | | | | | | | | |
| Comparative | | | | | | | | 300 |
| Example 3 | | | | | | | | |
| Comparative | Isobutyl | | | 10 | 65 | — | | 300 |
| Example 4 | methacrylate | | | | | | | |
| Comparative | polymer | | | | | | | 150 |
| Example 5 | | | | | | | | |
| Comparative | | | | 2.5 | 5 | 67.5 | | 300 |
| Example 6 | | | | | | | | |
| Comparative | | | | | | | | 150 |
| Example 7 | | | | | | | | |
| Comparative | | | | 10 | 65 | — | | 300 |
| Example 8 | | | | | | | | |
| Comparative | | | | | | | | 150 |
| Example 9 | | | | | | | | |
| Comparative | | | | 2.5 | 5 | 67.5 | | 300 |
| Example 10 | | | | | | | | |
| Comparative | | | | | | | | 150 |
| Example 11 | | | | | | | | |
| Comparative | Ethyl cellulose | | | 10 | 65 | — | | 300 |
| Example 12 | | | | | | | | |
| Comparative | Isobutyl | | | 2.5 | 5 | 67.5 | | 150 |
| Example 13 | methacrylate | | | | | | | |
| | polymer | | | | | | | |
| Comparative | | | 2 | 2.5 | 5 | 67.5 | | 150 |
| Example 14 | | | | | | | | |
| Comparative | | | 60 | | | | | 150 |
| Example 15 | | | | | | | | |
| Comparative | | | 2 | | | | | 150 |
| Example 16 | | | | | | | | |
| Comparative | | | 60 | | | | | 150 |
| Example 17 | | | | | | | | |

| | | Irradiation | | | | | |
|---|---|---|---|---|---|---|---|
| | | time with | | Total | Irradiation with pulsed light | | |
| | Irradiation | ultraviolet | | amount of | Amount of | Irradiation | |
| | intensity | light | Ultraviolet light | light | light | time | Number |
| | (mW/cm²) | (min.) | irradiation method | (J/cm²) | (J/cm²) | (msec) | of times |
| Comparative | 100 | 30 | From front side only | 180 | — | — | — |
| Example 1 | | | | | | | |
| Comparative | 100 | 60 | From front side only | 360 | — | — | — |
| Example 2 | | | | | | | |
| Comparative | 100 | 600 | From front side only | 3600 | — | — | — |
| Example 3 | | | | | | | |
| Comparative | 100 | 15 | From front side only | 90 | — | — | — |
| Example 4 | | | | | | | |
| Comparative | 100 | 15 | From front side only | 90 | — | — | — |
| Example 5 | | | | | | | |
| Comparative | 100 | 15 | From front side only | 90 | — | — | — |
| Example 6 | | | | | | | |
| Comparative | 100 | 15 | From front side only | 90 | — | — | — |
| Example 7 | | | | | | | |
| Comparative | 0 | 0 | From front side only | 0 | — | — | — |
| Example 8 | | | | | | | |
| Comparative | 0 | 0 | From front side only | 0 | — | — | — |
| Example 9 | | | | | | | |
| Comparative | 0 | 0 | From front side only | 0 | — | — | — |
| Example 10 | | | | | | | |
| Comparative | 0 | 0 | From front side only | 0 | — | — | — |
| Example 11 | | | | | | | |
| Comparative | 0 | 0 | From front side only | 0 | — | — | — |
| Example 12 | | | | | | | |
| Comparative | 100 | 15 | From front side for | 90 | — | — | — |
| Example 13 | | | 7.5 min. + from rear | | | | |
| | | | side for 7.5 min. | | | | |
| Comparative | 100 | 30 | From front side only | 180 | — | — | — |
| Example 14 | | | | | | | |
| Comparative | 100 | 30 | From front side only | 180 | — | — | — |
| Example 15 | | | | | | | |
| Comparative | 100 | 60 | From front side only | 360 | — | — | — |
| Example 16 | | | | | | | |
| Comparative | 100 | 60 | From front side only | 360 | — | — | — |
| Example 17 | | | | | | | |

### <Evaluation>

The porous titanium oxide layers and the dye-sensitized solar cells obtained in the examples and comparative examples were evaluated as follows. Table 3 shows the results.

### (1) Measurement of Variation in the Amount of Organic Residue in Porous Titanium Oxide Layer

Using an XPS analyzer (product of ULVAC-PHI, INCORPORATED, PHI5000), the carbon peak of a thin-film surface of the porous titanium oxide layer was measured after removal of a contaminated surface layer by sputtering to the depth of 100 nm. The measured values thus obtained and before the irradiation with ultraviolet light were compared for relative evaluation of the amount of organic residues left in the film.

The peak strength, relative to the peak strength of the carbon peak before irradiation with ultraviolet light, of 100% or lower but higher than 50% was rated to be “poor (X)”, the peak strength of 50% or lower but higher than 25% was rated to be “not good (Δ)”, the peak strength of 25% or lower but higher than 10% was rated to be “good (O)”, and the peak strength of 10% or lower was rated to be “excellent (OO)”.

### (2) Measurement of the Amount of Dye Adsorbed to Porous Titanium Oxide Layer

The amount of adsorbed dyes was determined as follows. The porous titanium oxide layer to which sensitizing dyes were adsorbed obtained in the (production of dye-sensitized solar cell) was immersed in a potassium hydroxide solution so that the sensitizing dyes were desorbed. The resulting desorption liquid was measured for a light absorption spectrum using a spectrophotometer (U-3000, product of Hitachi, Ltd.), thereby determining the amount of adsorbed dyes. The calculation was performed in which a relative change rate used was the value obtained by the formula [{(amount of adsorbed dye in a case where irradiation with ultraviolet light was performed)/(amount of adsorbed dye in a case where irradiation with ultraviolet light was not performed)} ×100] wherein the titanium oxide paste used and the firing conditions employed were the same.

### (3) Evaluation on Sinterability

A 10-cm square porous titanium oxide layer was formed by the same method as that in the examples and comparative examples. The layer was subjected to a pencil hardness test (JIS K 5600) for measurement of the sintering degree of the titanium oxide fine particles.

### (4) Performance Evaluation on Dye-Sensitized Solar Cell

Between the electrodes of the obtained dye-sensitized solar cell, a power source (236 model, product of KEYTHLEY) was connected, and the photoelectric conversion efficiency of the dye-sensitized solar cell was measured using a solar simulator (product of YAMASHITA DENSO) at a strength of 100 mW/cm². The calculation was performed in which a relative change rate used was the value obtained by the formula [{(photoelectric conversion efficiency in a case where irradiation with ultraviolet light was performed)/(photoelectric conversion efficiency in a case where irradiation with ultraviolet light was not performed)}×100] wherein the titanium oxide paste used and the firing conditions employed were the same.

TABLE 3

| | Variation in | | | | | | Photoelectric | |
|---|---|---|---|---|---|---|---|---|
| | amount of organic | | Amount of | | Evaluation on | | conversion | |
| | residue in film | | adsorbed dye | | sinterability | | efficiency | |
| | | Peak intensity | | Relative | Surface | | Measured | Relative |
| | Relative | ratio | Measured value | change rate | resistance | Pencil | value | change rate |
| | evaluation | (%) | (×10⁻⁸ mol/cm²) | (%) | (×10⁹ Ω/cm²) | hardness | (%) | (%) |
| Example 1 | ◯◯ | 3.02 | 4.88 | 116 | — | — | 7.92 | 129 |
| Example 2 | ◯◯ | 2.74 | 5.14 | 122 | — | — | 7.98 | 130 |
| Example 3 | ◯ | 8.69 | 2.23 | 2069 | — | — | 4.05 | 2830 |
| Example 4 | ◯ | 7.06 | 2.48 | 2297 | — | — | 4.39 | 3070 |
| Example 5 | ◯◯ | 2.66 | 6.59 | 135 | — | — | 8.79 | 135 |
| Example 6 | ◯◯ | 1.88 | 6.83 | 140 | — | — | 8.98 | 138 |
| Example 7 | ◯ | 8.21 | 3.10 | 2693 | 1350 | F | 4.56 | 3040 |
| Example 8 | ◯ | 5.93 | 3.33 | 2899 | — | — | 4.68 | 3100 |
| Example 9 | ◯◯ | 3.79 | 3.36 | 2921 | — | — | 5.07 | 3358 |
| Example 10 | ◯◯ | 2.11 | 3.53 | 3069 | — | — | 5.14 | 3404 |
| Example 11 | ◯◯ | 4.81 | 3.29 | — | — | — | 4.51 | — |
| Example 12 | ◯ | 9.22 | 2.77 | — | — | — | 3.68 | — |
| Example 13 | ◯◯ | 3.69 | 3.51 | — | — | — | 4.81 | — |
| Example 14 | ◯ | 7.89 | 2.80 | — | — | — | 3.96 | — |
| Example 15 | ◯◯ | 4.94 | 3.29 | — | — | — | 4.87 | — |
| Example 16 | ◯ | 7.33 | 3.21 | — | — | — | 4.67 | — |
| Example 17 | ◯◯ | 4.61 | 3.28 | — | — | — | 4.70 | — |
| Example 18 | ◯◯ | 4.46 | 3.45 | — | — | — | 5.04 | — |
| Example 19 | ◯ | 5.10 | 3.37 | — | — | — | 4.71 | — |
| Example 20 | ◯◯ | 3.89 | 3.40 | — | — | — | 4.76 | — |
| Example 21 | — | — | — | — | 8.20 | H | 6.34 | — |
| Example 22 | — | — | — | — | 36.74 | H | 5.72 | — |
| Example 23 | — | — | — | — | 12.04 | 2H | 6.23 | — |
| Example 24 | — | — | — | — | 187.00 | F | 4.79 | — |
| Example 25 | — | — | — | — | 21.66 | 3H | 5.94 | — |
| Example 26 | — | — | — | — | 4.99 | 2H | 6.88 | — |
| Example 27 | — | — | — | — | 7.11 | 2H | 6.76 | — |
| Example 28 | — | — | — | — | 5.71 | 2H | 6.59 | — |
| Example 29 | — | — | — | — | 622.00 | F | 4.67 | — |
| Comparative | X | 39.65 | 1.06 | 94 | — | — | 1.54 | 100 |
| Example 1 | | | | | | | | |
| Comparative | X | 30.11 | 1.20 | 106 | — | — | 1.54 | 100 |
| Example 2 | | | | | | | | |
| Comparative | Δ | 23.87 | 1.37 | 121 | — | — | 1.68 | 109 |
| Example 3 | | | | | | | | |
| Comparative | X | 28.44 | 4.55 | 108 | — | — | 7.00 | 114 |
| Example 4 | | | | | | | | |
| Comparative | Δ | 14.89 | 1.04 | 967 | — | — | 2.27 | 1587 |
| Example 5 | | | | | | | | |
| Comparative | X | 26.24 | 5.71 | 117 | — | — | 7.23 | 111 |
| Example 6 | | | | | | | | |
| Comparative | Δ | 13.24 | 0.92 | 799 | — | — | 1.88 | 1244 |
| Example 7 | | | | | | | | |
| Comparative | X | 40.32 | 4.21 | 100 | — | — | 6.14 | 100 |
| Example 8 | | | | | | | | |
| Comparative | X | 69.41 | 1.08 × 10⁻³ | 100 | — | — | 1.43 × 10⁻³ | 100 |
| Example 9 | | | | | | | | |
| Comparative | X | 38.74 | 4.88 | 100 | — | — | 6.51 | 100 |
| Example 10 | | | | | | | | |
| Comparative | X | 66.98 | 1.15 × 10⁻³ | 100 | — | — | 1.51 × 10⁻³ | 100 |
| Example 11 | | | | | | | | |
| Comparative | X | 46.11 | 1.13 | 100 | — | — | 1.54 | 100 |
| Example 12 | | | | | | | | |
| Comparative | Δ | 10.45 | 1.02 | 887 | — | — | 2.34 | 1549 |
| Example 13 | | | | | | | | |
| Comparative | Impossible to form and evaluate film due to remarkable aggregation | | | | | | | |
| Example 14 | | | | | | | | |
| Comparative | Δ | 19.22 | 1.93 | — | — | — | 2.48 | — |
| Example 15 | | | | | | | | |
| Comparative | Impossible to form and evaluate film due to remarkable aggregation | | | | | | | |
| Example 16 | | | | | | | | |
| Comparative | Δ | 14.26 | 1.98 | — | — | — | 2.73 | — |
| Example 17 | | | | | | | | |

### INDUSTRIAL APPLICABILITY

The present invention provides a method for producing a porous titanium oxide laminate which enables production of a porous titanium oxide layer having a high porosity and containing fewer impurities even through low-temperature firing, and a dye-sensitized solar cell including the porous titanium oxide laminate.

1. A method for producing a porous titanium oxide laminate comprising the steps of:
printing a titanium oxide paste containing titanium oxide fine particles, a (meth)acrylic resin, and an organic solvent on a base material for forming a titanium oxide paste layer on the base material;
firing the titanium oxide paste layer; and
irradiating the fired titanium oxide paste layer with ultraviolet light,
the titanium oxide fine particles having an average particle size of 5 to 50 nm,
the ultraviolet light being radiated in a total amount of 100 J/cm² or more in the step of irradiating the fired titanium oxide paste layer with ultraviolet light.

2. The method according to claim 1,
wherein the (meth)acrylic resin is polyisobutyl methacrylate.

3. The method according to claim 1,
wherein the organic solvent has a boiling point of 100 to 300° C.

4. A dye-sensitized solar cell comprising the porous titanium oxide laminate produced by the method according to claim 1.

5. The method according to claim 2,
wherein the organic solvent has a boiling point of 100 to 300° C.

6. A dye-sensitized solar cell comprising the porous titanium oxide laminate produced by the method according to claim 2.

7. A dye-sensitized solar cell comprising the porous titanium oxide laminate produced by the method according to claim 3.

8. A dye-sensitized solar cell comprising the porous titanium oxide laminate produced by the method according to claim 5.
